(19) United States
(12) Patent Application Publication
(10) Pub. No.: US 2024/0320884 A1
(43) Pub. Date: Sep. 26, 2024

(54) ACCESS POLICY DISPLAY DEVICE AND ACCESS POLICY DISPLAY METHOD

(71) Applicant: NEC Corporation, Tokyo (JP)

(72) Inventors: Masaki Inokuchi, Tokyo (JP); Shunichi Kinoshita, Tokyo (JP); Shohei Mitani, Tokyo (JP)

(73) Assignee: NEC Corporation, Tokyo (JP)

(21) Appl. No.: 18/595,622

(22) Filed: Mar. 5, 2024

(30) Foreign Application Priority Data
Mar. 23, 2023 (JP) 2023-046154

(51) Int. Cl. G06T 11/20; G06F 21/62; G06T 11/00

(52) U.S. Cl. CPC G06T 11/206; G06F 21/6218; G06T 11/001

(57) ABSTRACT

An access policy display device includes an image generation unit which sets an image region for each combination of an attribute value of one attribute and an attribute value of another attribute in two attributes selected from two or more attributes constituting a condition of an access policy, calculates the degree of access permission or access denial in a plurality of the combinations, and generates an image in which a plurality of the image regions is displayed that allows for distinguishing the degree, and a display which displays the image.

### CROSS-REFERENCE TO RELATED APPLICATION

This application is based upon and claims the benefit of priority from the prior Japanese Patent Application 2023-046154, filed on Mar. 23, 2023, the entire contents of which are incorporated herein by reference.

### BACKGROUND OF THE INVENTION

### Field of the Invention

This invention relates to an access policy display device and an access policy display method for visualizing an access policy.

### Description of the Related Art

Access control may be performed based on access policy.

There is a device configured to display an access policy or information based on an access policy in order to make it easier for a user to understand the access policy (for example, refer to Patent literature 1 and 2).

Patent literature 1 describes that a rule based on an access policy is represented in an if-then format. Patent literature 2 describes use of a decision tree to analyze access.
[Patent Literature 1] Japanese Patent Application Publication No. 2022-126712
[Patent Literature 2] Japanese Patent Application Publication No. 2022-50462

### SUMMARY OF THE INVENTION

Assume a rule based on an access policy is represented in an if-then format. When texts are displayed in an if-then format to help a user understand the access policy, the number of lines of text increases and visibility decreases in case there are many attributes used to determine the rights and wrongs of the access policy.

When a decision tree is displayed to make it easier for a user to understand the access policy, the image size increases, and visibility also decreases.

It is an object of the present invention to provide an access policy display device and an access policy display method that can display information regarding an access policy with improved visibility.

A preferred aspect of the access policy display device includes an image generation unit which sets an image region for each combination of an attribute value of one attribute and an attribute value of another attribute in two attributes selected from two or more attributes constituting a condition of an access policy, calculates the degree of access permission or access denial in a plurality of the combinations, and generates an image in which a plurality of the image regions is displayed that allows for distinguishing the degree, and a display which displays the image.

A preferred aspect of the access policy display method includes setting an image region for each combination of an attribute value of one attribute and an attribute value of another attribute in two attributes selected from two or more attributes constituting a condition of an access policy, calculating the degree of access permission or access denial in a plurality of the combinations, and generating an image in which a plurality of the mage regions is displayed that allows for distinguishing the degree, and displaying the image.

A preferred aspect of an access policy display program for causing a computer to execute setting an image region for each combination of an attribute value of one attribute and an attribute value of another attribute in two attributes selected from two or more attributes constituting a condition of an access policy, calculating a degree of access permission or access denial in a plurality of the combinations, and generating an image in which a plurality of the image regions is displayed that allows for distinguishing the degree; and displaying the image.

According to the present invention, information regarding an access policy with improved visibility can be displayed.

### BRIEF DESCRIPTION OF THE DRAWINGS

FIG. 1 It depicts an explanatory diagram showing an example of attribute definition information.

FIG. 2 It depicts a block diagram showing an example configuration of an access policy display device of the first example embodiment.

FIG. 3 It depicts an explanatory diagram showing an example of the process of a policy image generation unit.

FIG. 4 It depicts an explanatory diagram showing an example of the process of a policy image generation unit.

FIG. 5 It depicts an explanatory diagram showing an example of the process of an information addition unit.

FIG. 6 It depicts an explanatory diagram showing an example of a display on a display device.

FIG. 7 It depicts an explanatory diagram showing an example of the relationship between a two-dimensional image and an example display.

FIG. 8 It depicts a flowchart showing the operation of an access policy display device of the first example embodiment.

FIG. 9 It depicts a block diagram showing an example configuration of an access policy display device of the second example embodiment.

FIG. 10 It depicts an explanatory diagram showing an example of information input from an attribute value input unit and a display on a display device in the second example embodiment.

FIG. 11 It depicts a flowchart showing the operation of an access policy display device of the second example embodiment.

FIG. 12 It depicts a block diagram showing an example configuration of an access policy display device of the third example embodiment.

FIG. 13 It depicts an explanatory diagram showing an example of a policy definition.

FIG. 14 It depicts an explanatory diagram showing an example of a process of an attribute value determination unit in the third embodiment and an example of a display on a display device.

FIG. 15 It depicts a flowchart showing the operation of an access policy display device of the third example embodiment.

FIG. 16 It depicts a block diagram showing an example configuration of an access policy display device of the fourth example embodiment.

FIG. 17 It depicts an explanatory diagram showing an example of trend information.

FIG. 18 It depicts an explanatory diagram showing an example of a display of a policy image generated with reference to trend information.

FIG. 19 It depicts a flowchart showing the operation of an access policy display device of the fourth example embodiment.

FIG. 20 It depicts an explanatory diagram for explaining the first modification.

FIG. 21 It depicts an explanatory diagram for explaining the first modification.

FIG. 22 It depicts an explanatory diagram for explaining the first modification.

FIG. 23 It depicts an explanatory diagram showing an example of a display in the second modification.

FIG. 24 It depicts a block diagram showing a computer with a CPU.

FIG. 25 It depicts a block diagram showing the main part of an access policy display device.

### DESCRIPTION OF THE PREFERRED EMBODIMENTS

Hereinafter, example embodiments of the present invention will be explained with reference to the drawings.

First, the terms used in this specification are explained.

Access policy information: This information can be used to determine access permission or access denial to input access attributes. Access policy information may be represented as a function that returns a determination of access permission or access denial for a combination of attributes. Access policy information can be represented as an if-then form rule, a decision tree, a neural network model, a correspondence table, etc. Hereafter, an access policy is sometimes simply referred to as a policy.

Access Attribute: This is a type related to access. For example, a type of accessor, a type of access level, a type of resource to be accessed, or a type of action to be performed at an access destination (read, write, execute, etc.). Hereafter, the access attribute is sometimes simply referred to as an attribute.

Attribute definition information: This information includes information such as possible values of an attribute (an attribute value) used to determine an access policy and how to delimit a region when outputting images. When the attribute definition information is represented by a categorical variable, the attribute definition information is a set of labels that the variable can take. When the attribute definition information is represented by a numeric variable, the attribute definition information defines a range of a value that the variable can take and a step width of an image output. When the attribute value is a vector, each element of the vector is considered a different attribute, and a definition range and a step width are defined.

Additional information: This information includes access-related information. The access-related information includes at least information related to access permission or access denial. The access-related information is displayed superimposed on an access policy image (policy image). The additional information includes, for example, an access log, a communication log, and an existing policy. Note that the policy image is, for example, a two-dimensional image that indicates a range where access is permitted and a range where access is denied.

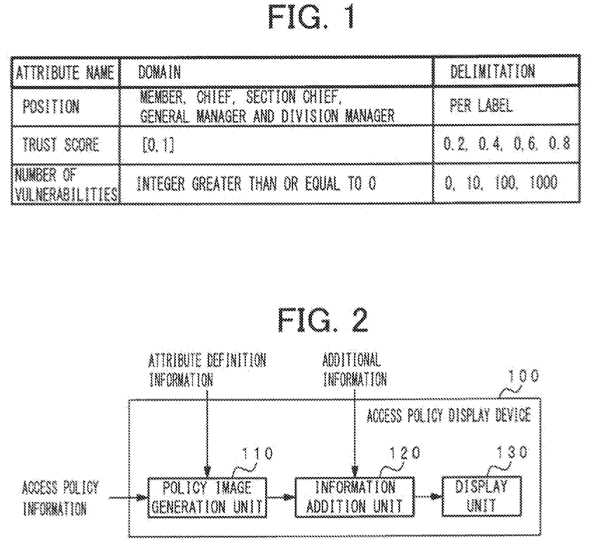

FIG. 1 is an explanatory diagram showing an example of the attribute definition information. In FIG. 1, three attributes are illustrated. For an attribute of “Position,” a set of labels as attribute definition information is exemplified as a domain. For an attribute of “Trust Score” (credibility), a range of a value that a variable can take is illustrated as a domain. For an attribute “Number of vulnerabilities,” a possible value of an attribute value is illustrated as a domain.

### Example Embodiment 1

FIG. 2 is a block diagram showing an example configuration of an access policy display device of the first example embodiment. The access policy display device 100 shown in FIG. 2, comprises a policy image generation unit 110, an information addition unit 120, and a display device 130. The arrows in FIG. 2 indicate the direction of signal (data) flow in a straightforward manner, but do not preclude bidirectionality. This is also true for the other block diagrams.

The policy image generation unit 110 generates a two-dimensional image consisting of an image region (hereinafter referred to as “region”) corresponding to any combination of a value of one of the two attributes (attribute X, Y) and a value of the other attribute. The policy image generation unit 110 determines whether access should be permitted or denied for each sample, according to access policy information. Then, a type of display of a region in the two-dimensional image is determined according to an access permission ratio “[number of access permissions/(number of access permissions+number of access denials)].”

In this example embodiment, a type of display of a region is a type of color. The type of color is, for example, a shade of color. The type of color may be the color itself (red, blue, yellow, etc.). In other words, the policy image generation unit 110 determines the display color (shading or color itself) of a region according to a ratio of access permissions. A two-dimensional image in which a region is colored is called a policy image.

It should be noted that a type of display being a type of color is just one example. As long as a ratio of access permissions can be distinguished, a type of display of a region is not limited to a type of color. For example, it is possible to make the difference in a ratio of access permissions recognizable by the difference in a pattern. It is also possible to make the difference in a ratio of access permissions recognizable by changing the way a border of a region is drawn.

The information addition unit 120 adds information related to access permission or access denial included in additional information to a policy image. In other words, the information addition unit 120 superimposes access-related information on a policy image. Hereinafter, a policy image to which information related to access permission or access denial included in additional information is added may be referred to as a policy image with additional information.

The display device 130 displays one or more policy images with additional information.

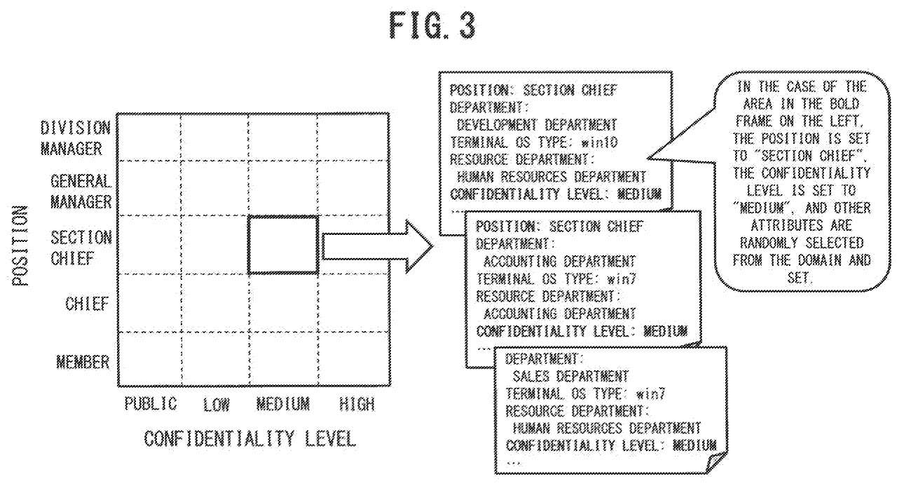

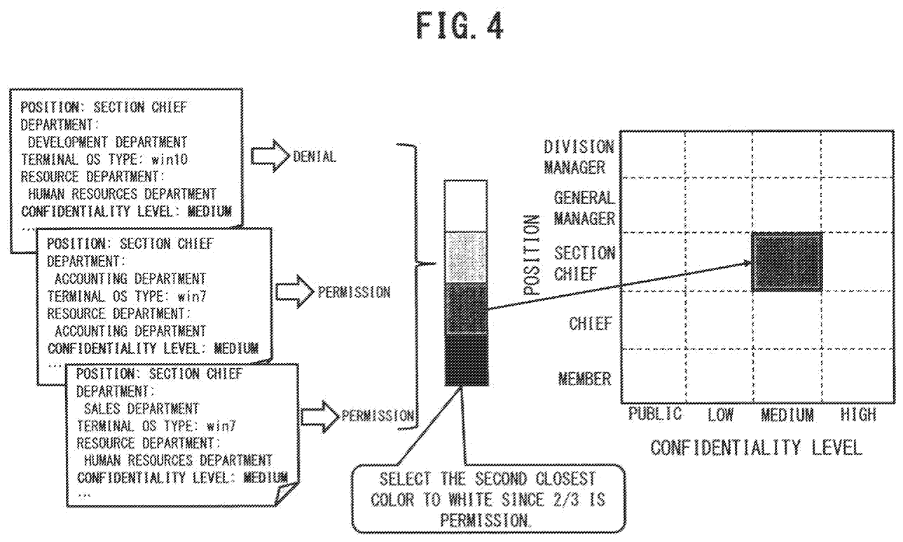

FIG. 3 and FIG. 4 are explanatory diagrams showing examples of the process of the policy image generation unit 110.

The policy image generation unit 110 selects attributes X and Y. In the example shown in FIG. 3, “Confidentiality Level” and “Position” are selected as attributes X and Y. The policy image generation unit 110 assigns attribute Y to the vertical axis and attribute X to the horizontal axis in a two-dimensional image.

Based on the attribute definition information, the policy image generation unit 110 divides a region by a specified delimitation method (refer to FIG. 1) within the range of possible values of attributes X and Y. In the example shown in FIG. 3, the vertical axis is delimited by “Member,” “Chief,” “Section Chief,” “General Manager,” and “Division Manager.” The horizontal axis is delimited by “Public,” “Low,” “Medium,” and “High.”

For each region, the policy image generator 110 generates samples with randomly varying values for attributes other than attributes X and Y. FIG. 3 shows an example of a region with the Position “Section Chief” and the Confidentiality Level “Medium.” In other words, FIG. 3 shows an example in which a plurality of samples is generated in which values of attributes other than “Section Chief” and “Medium” are randomly changed.

Further, the policy image generation unit 110 determines whether an access should be permitted or denied based on the access policy information for each sample of attribute values generated. FIG. 4 shows an example where two samples are determined to be access permitted and one sample is determined to be access denied.

The policy image generation unit 110 determines the color of a region to be the color corresponding to a ratio of access permissions. FIG. 4 illustrates that the ratio of access permissions is [2/3], and the color is determined to be the second closest to white (specifically, the second closest density to white).

However, the case in which the values of attributes X and Y are “Section Chief” and “Medium” is illustrated in FIG. 3 and FIG. 4, the policy image generation unit 110 determines the color of a region for all combinations of all Position values (“Member,” “Chief,” “Section Chief,” “General Manager,” and “Division Manager”) and all Confidentiality Level values (“Public,” “Low,” “Medium” and “High”) in the same manner as for the combination of “Section Chief” and “Medium.”

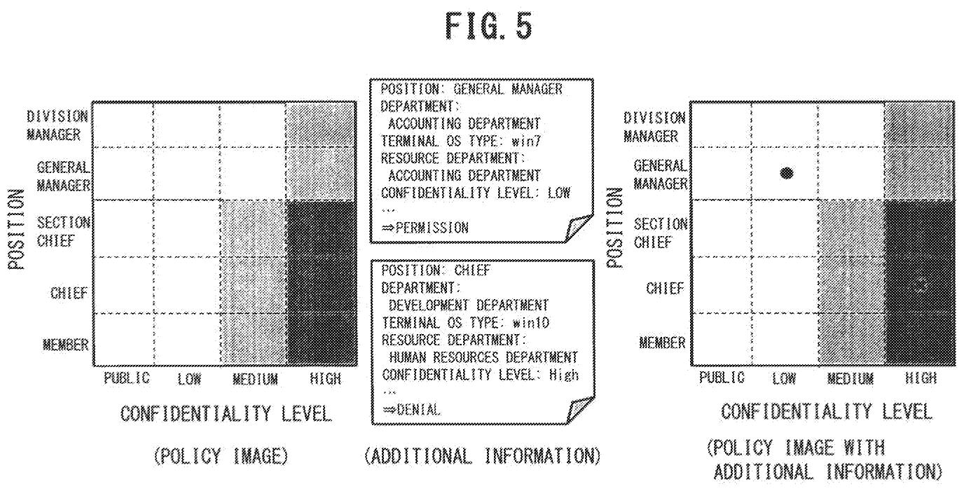

FIG. 5 is an explanatory diagram showing an example of a process of an information addition unit 120.

As described above, the information addition unit 120 adds information related to access permission or access denial contained in additional information to a policy image. As described above, additional information is, for example, an access log, a communication log, or an existing policy.

The information addition unit 120 adds, for example, a mark (a circle as an example) that can be used to understand access permission according to cases of access permission included in additional information. The information addition unit 120 adds, for example, a mark (an X as an example) that can be used to understand access denial according to cases of access denial included in additional information.

Note that when there is a plurality of logs, etc., corresponding to a region, the information addition unit 120 determines, for example, by majority vote, whether to add a mark that can be used to understand access permission or a mark that can be used to understand access denial. When there is a plurality of logs, etc., corresponding to a region, the information addition unit 120 may give priority to either access permission or access denial. The information addition unit 120 may also indicate regions where no access logs, communication logs, existing policies, etc., exist with a color different from the color indicated according to a ratio of access permissions.

FIG. 5 illustrates an example that there are logs indicating “General Manager,” “Low,” and “Permitted,” and logs indicating “Chief,” “High,” and “Denied.”

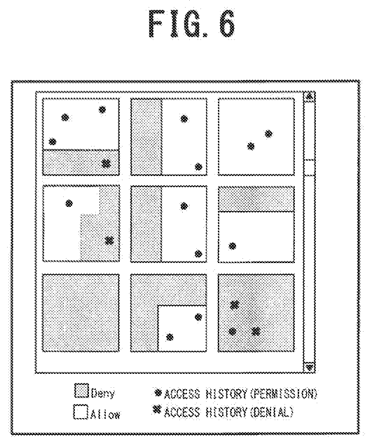

FIG. 6 is an explanatory diagram showing an example of a display on the display device 130. “Deny” in FIG. 6 indicates access denied. “Allow” indicates access permission.

FIG. 6 shows an example of a case in which the policy image generation unit 110 generates a policy image for each of a plurality of combinations of attributes X and Y. FIG. 6 illustrates a case in which the policy image generation unit 110 generates nine different policy images.

After adding information related to access permission or access denial that be included in additional information to each of a plurality of policy images, the information addition unit 120 outputs an image signal to the display device 130 such that the plurality of policy images with the additional information is displayed side by side. The display device 130 displays the plurality of policy images side by side on a single screen.

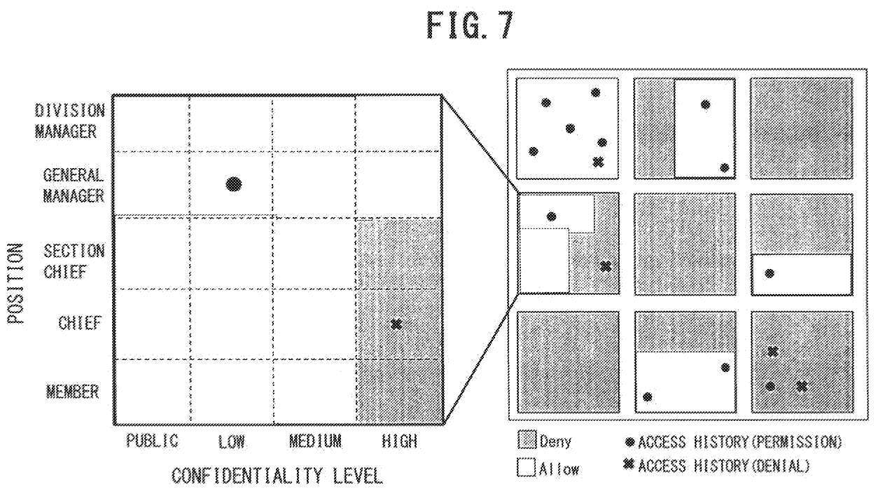

FIG. 7 is an explanatory diagram showing an example of the relationship between a two-dimensional image and an example display. The left side of FIG. 7 shows the policy image illustrated in FIG. 3. The eight policy images shown on the right side of FIG. 7, other than the policy image illustrated in FIG. 3, are a plurality of policy images created by the policy image generation unit 110, like the policy image illustrated in FIG. 3 (but with different combinations of attributes).

By displaying a plurality of policy images with additional information side by side, a user can easily understand an entire policy visually.

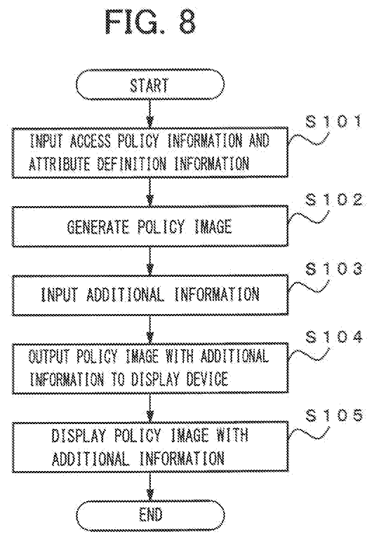

Next, an operation of the first example embodiment of the access policy display device 100 is explained with reference to the flowchart in FIG. 8.

The policy image generation unit 110 inputs the access policy information and the attribute definition information (step S101). The policy image generation unit 110 generates a policy image, as explained with reference to FIG. 3 and FIG. 4 (step S102).

The information addition unit 120 inputs additional information (step S103). The information addition unit 120 adds the additional information to the policy image, as explained with reference to FIG. 5. The information addition unit 120 then outputs an image signal of the policy image with additional information to the display device 130 (step S104). The image signal output to the display device 130 is, for example, a signal to display the image illustrated in FIG. 6.

The display device 130 displays, for example, the image illustrated in FIG. 6 using the image signal from the information adding section 120 (step S105).

Note that the input timing of access policy information, attribute definition information, and additional information is not limited to the timing shown in FIG. 8. For example, the input timing of attribute definition information and additional information may be input to the policy image generation unit 110 and the information addition unit 120 in advance.

As explained above, in this example embodiment, the policy image generation unit 110 generates a two-dimensional image consisting of a region corresponding to each of the combinations of attribute values. Further, the policy image generation unit 110 calculates a ratio of access permissions as an example of the degree of access permission. The policy image generation unit 110 changes the type of display of a region according to the ratio of access permissions. The information addition unit 120 superimposes access-related information on the region. By executing such a process, information regarding the access policy with improved visibility is displayed. Note that instead of calculating a ratio of access permissions, the policy image generation unit 110 may calculate a ratio of access denials “[number of access denials/(number of access permissions+number of access denials)].”

In this example embodiment, the policy image generation unit 110 generates a sample with a randomly set attribute value. However, the policy image generation unit 110 may generate a sample using an access log or a communication log. For example, the policy image generation unit 110 may use log information as a sample as it is. As an example, regarding the example shown in FIG. 3, an access log including Position: “section manager” and security level: “Medium” is extracted from a log storage unit (not shown), and the extracted access log is used as a sample.

The policy image generation unit 110 may also calculate the distribution of each attribute value based on an access log and a communication log and generate samples based on the distribution. For example, when the distribution of attribute values for the Position included in an access log is 0.4 for Member, 0.3 for Chief, 0.15 for Section Chief, 0.1 for General Manager, and 0.05 for Division Manager, the policy image generation unit 110 sets a sample so that attribute values set for the sample also follow that distribution.

Note that when the information addition unit 120 generates an image for each combination of attributes, it is expected that the number of images will become enormous and difficult to recognize visually. In addition, when the influence of attributes other than X and Y is large, it is expected that the ratio of access permissions for each region in an image will change only slightly when the values of attributes X and Y are changed, making it difficult to read information from the image.

The following example embodiment can prevent reduction in visibility that may occur in the first example embodiment.

### Example Embodiment 2

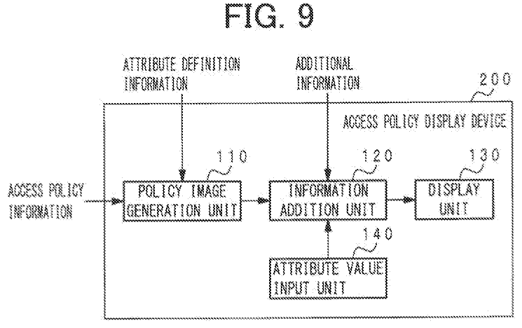

In the second example embodiment, reduction in visibility is prevented by providing an input unit (input interface) that can specify a specific value for each attribute. FIG. 9 is a block diagram showing an example configuration of the access policy display device 200 of the second example embodiment.

The access policy display device 200 shown in FIG. 9 comprises an attribute value input unit 140 in addition to the configuration of the access policy display device 100, shown in FIG. 2. The attribute value input unit 140 supplies information to the policy image generation unit 110 for identifying combinations of attribute values X and Y.

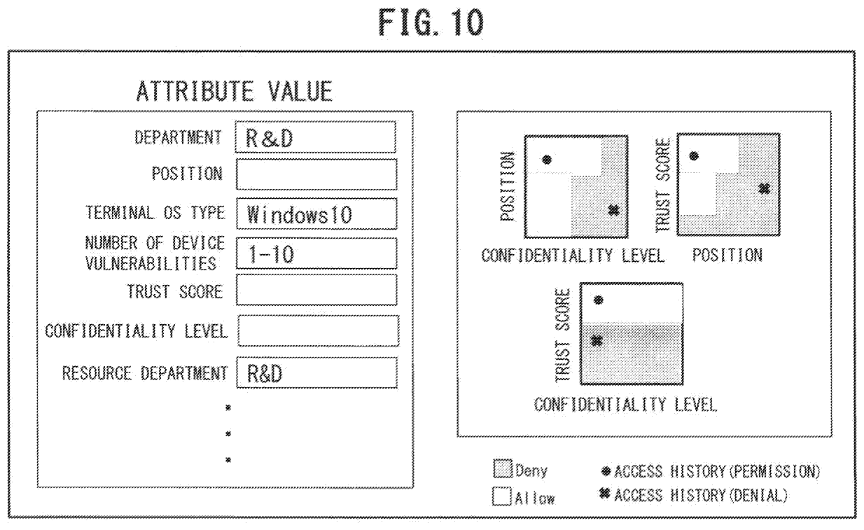

FIG. 10 is an explanatory diagram showing an example of information input from the attribute value input unit 140, and a display on a display device (not shown). Note that the display device 130 may also be used as the display device.

The attribute value input unit 140 comprises, for example, a graphical user interface (GUI).

The left side of FIG. 10 illustrates an entry screen for attribute values for each of a plurality of attributes. FIG. 10 shows that a user did not enter anything in the “Position,” “Trust Score,” and “Confidentiality Level” fields. In other words, the user left the fields for those attributes blank. FIG. 10 also illustrates that the user entered some values or data in a field for an attribute other than “Position,” “Trust Score,” and “Confidentiality Level.”

The attribute value input unit 140 supplies an attribute corresponding to a blank field to the policy image generation unit 110. The attribute value input unit 140 also supplies an entered value or data to the policy image generation unit 110 for an attribute corresponding to a field in which some value or data has been entered.

The policy image generation unit 110 generates a policy image for a combination of attributes X and Y corresponding to a blank field. In the first example embodiment, the policy image generation unit 110 generates a sample with randomly changed values of attributes other than attributes X and Y. In contrast, in the second example embodiment, the policy image generation unit 110 randomly sets a value of an attribute for which value has not been entered by the attribute value input unit 140 among the values of attributes other than attributes X and Y, and uses an entered value as a fixed value for an attribute for which a value has been entered. For example, when “Section Chief” is entered for attribute: Position, the policy image generation unit 110 always sets attribute: Position to “Section Chief” in the generated sample. Note that the policy image generation unit 110 may not generate a policy image for an attribute corresponding to a field in which some value or data is entered at all.

In other words, the attribute value input unit 140 has a function of inputting a specific attribute value for each attribute and a function of specifying an attribute to be used as an axis of a policy image. In the example shown in FIG. 10, it can be said that by leaving a field blank, an attribute to be used as an axis of a policy image is specified. When the number of types of attributes in the first example embodiment is N, then _{N}C₂ policy images will be generated. Note that ₙCᵣ represents the number of combinations for extracting r different pieces from n pieces. In the second example embodiment, the number of policy images can be reduced because the number of attributes used as an axe of a policy image is limited to a smaller number than N.

Further, it is expected that by setting some attribute values to fixed values, information can be read more clearly from an image. For example, consider an access policy where the attribute: Position is “Chief” or “Member” always returns denial regardless of other attributes, “General Manager” or “Division Manager” always returns permission, and only “Section Chief” depends on other attributes to determine whether access is permitted or denied. In the first example embodiment, in a policy image for attributes X and Y other than Position, when a sample is generated so that all Positions are equally represented, 40% of the total is determined to be permitted (those with Position is “General Manager” or “Division Manager”) and 40% of the total is determined to be denied (those with Position is “Chief” or “Member”) regardless of the values of attributes X and Y. In other words, a ratio of access permissions is limited to a range of 0.4 to 0.6. On the other hand, in the second example embodiment, when the attribute value input unit 140 specifies “Section Chief” in a “Position” field, a sample generated will be only “Section Chief” and will not be subject to such a limitation. This allows a wider range of values for which a ratio of access permissions is taken, which can be recognized as a clearer difference in a policy image.

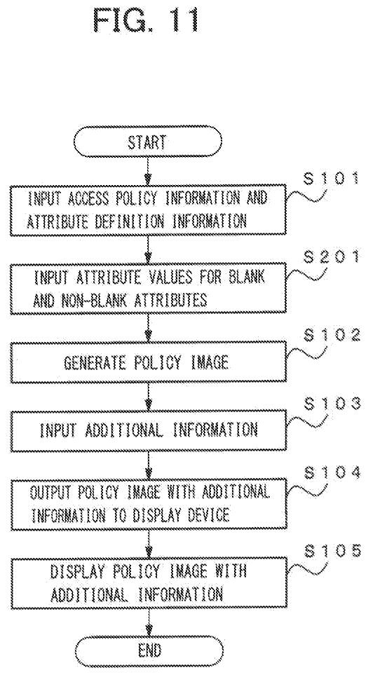

Next, an operation of the access policy display device 200 of the second example embodiment is explained with reference to the flowchart in FIG. 11. The processes other than the process of step S201 are the same as the processes executed by the access policy display device 100 of the first example embodiment (refer to FIG. 8). However, the process of step S102 is slightly different from the process in the first example embodiment.

In step S201, the attribute value input unit 140 inputs attributes corresponding to a blank field through the GUI and also inputs entered values or data for attributes corresponding to a field in which some value or data has been entered. The attribute value input unit 140 supplies them to the policy image generation unit 110.

The policy image generation unit 110 generates a policy image for limited attributes X and Y, as described above. When generating a sample for access permission/access denial determination, the policy image generation unit 110 uses the value as a fixed value for an attribute for which a value has been entered.

The right side of FIG. 10 shows an example of a display on the display device 130. In the example shown in FIG. 10, the “Position,” “Trust Score” and “Confidentiality Level” fields are blank (refer to left side in FIG. 10), so the policy image generation unit 110 generates a policy image corresponding to attribute X, Y: “Position” and “Confidentiality Level,” a policy image corresponding to attribute X, Y: “Trust Score” and “Position,” and a policy image corresponding to attribute X, Y: “Trust Score” and “Confidentiality Level”.

As in the case of the first example embodiment, the information addition unit 120 adds additional information to a policy image and outputs an image signal of the policy image to the display device 130. As a result, the display device 130 displays, for example, a display illustrated on the right side of FIG. 10.

In this example embodiment, the number of images is reduced because policy images are generated for only a limited number of combinations of attributes. In addition, by using fixed values for some attributes, the influence of the attribute value on access permission determination is eliminated, and a policy image can be more clearly visible. Therefore, reduction in visibility of a policy image is prevented.

Note that in the second example embodiment, the value entered for each attribute is not necessarily one. It is also possible to accept a plurality of values for one attribute. In that case, the policy image generation unit 110 can randomly select a value from a plurality of values entered during sample generation. For example, when two values, “Section Chief” and “Chief,” are entered in the field for attribute: Position, the policy image generation unit 110 randomly selects either “Section Chief” or “Chief” as an attribute value for attribute: Position during sample generation.

### Example Embodiment 3

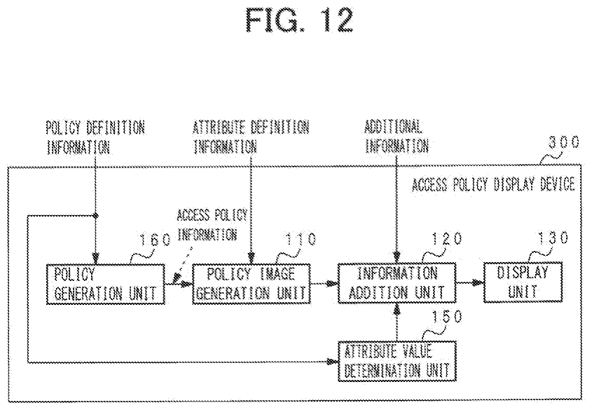

In the third embodiment, reduction in visibility is prevented by specifying a value for each attribute using rule definition information used to generate policy information. FIG. 12 is a block diagram showing an example configuration of an access policy display device 300 of the third example embodiment.

The access policy display device 300, shown in FIG. 12, is configured by adding a policy generation unit 160 to the configuration of the access policy display device 200, shown in FIG. 9. However, in the third embodiment, instead of the attribute value input section 140, an attribute value determination unit 150 that uses a policy definition (policy definition information) is included.

The policy definition information includes information on whether access is permitted or denied when an attribute value takes a specific value or a value in a specific range.

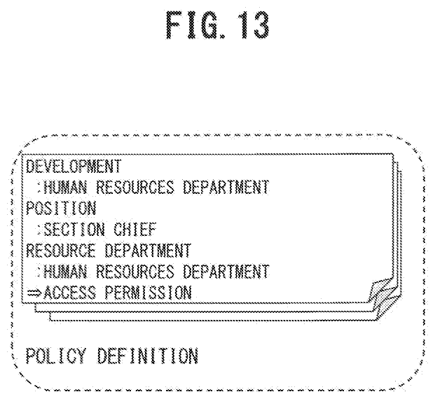

FIG. 13 is an explanatory diagram showing an example of a policy definition. In the example shown in FIG. 13, a policy definition includes information indicating that access is permitted when an attribute: attribute value of affiliation to is “Human Resources Department,” an attribute: attribute value of Position is “Section Chief,” and an attribute: resource department is “Human Resources Department.”

The policy generator 160 generates access policy information by supplementing deficiencies against the policy definition (coarse-grained policy definition) such as illustrated in FIG. 13. Note that supplementing adds an attribute not described in a policy definition among a plurality of predetermined attributes.

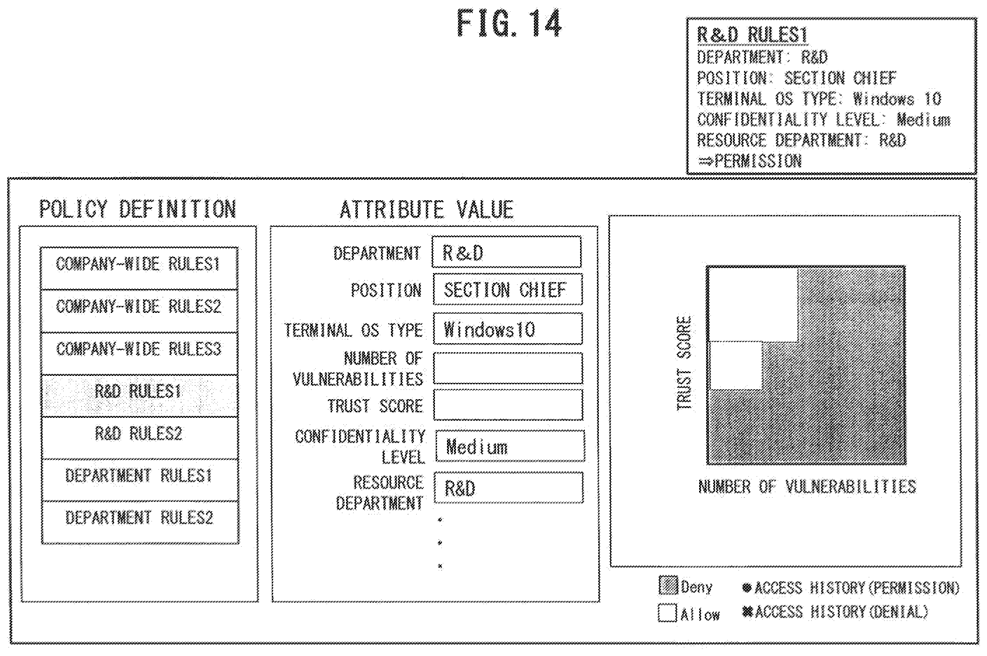

FIG. 14 is an explanatory diagram showing an explanatory diagram showing an example of a process of an attribute value determination unit 150 in the third embodiment and an example of a display on a display device. In the third example embodiment, a plurality of rules is predetermined as policy definitions.

The left side of FIG. 14 shows an example of a field for a user to select a policy definition. The center of FIG. 14 shows an example of an entry screen for attribute values for each of a plurality of attributes. Note that Windows” shown in FIG. 14 is a registered trademark.

When a user selects a specific policy definition, the attribute value determination unit 150 applies an attribute value described in the selected policy definition to the corresponding location on the entry screen for attribute values.

FIG. 14 shows illustrates that a user selecting a policy definition “R&D Rule 1”. The attribute value determination unit 150 applies an attribute and its attribute value described in “R&D Rule 1” to the corresponding locations on the entry screen.

As in the case of the second example embodiment, the policy image generation unit 110 generates a policy image with attributes corresponding to blank fields as attributes X and Y.

The right side in FIG. 14 shows an example of a display on the display device 130. In the example shown in FIG. 14, a policy image corresponding to attributes X, Y: “Number of Vulnerabilities” and “Trust Score” is generated. The “Number of Vulnerabilities” and “Trust Score” are attributes that are not included in “R&D Rule 1.”

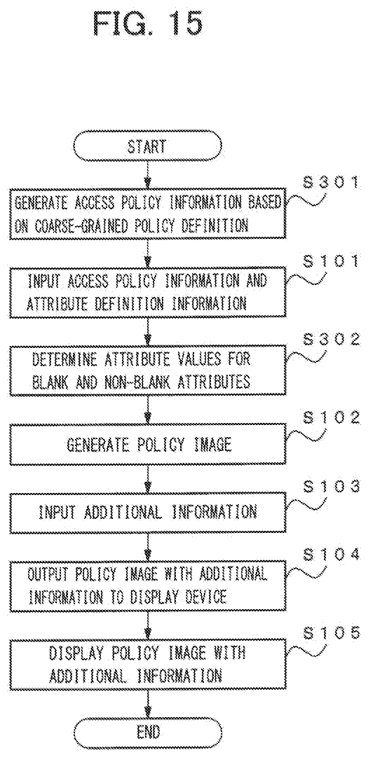

Next, an operation of the access policy display device 300 of the third example embodiment is explained with reference to the flowchart in FIG. 15. The processes other than the processes in steps S301 and S302 are the same as those executed by the access policy display device 200 of the second example embodiment (refer to FIG. 11).

In step S301, the policy generation unit 160 generates access policy information by supplementing deficiencies against a coarse-grained policy definition. The policy generation unit 160 outputs the generated access policy information to the policy image generation unit 110.

In step S302, the attribute value determination unit 150 determines attribute values for blank attributes and non-blank attributes. Specifically, the attribute value determination unit 150 sets attribute values for each attribute based on a policy definition selected through a GUI. The attribute value determination unit 150 supplies attributes corresponding to a blank field (a field for which no attribute value has been entered) to the policy image generation unit 110 and supplies entered values or data to the policy image generation unit 110 for attributes corresponding to a field in which some value or data is entered.

The other processes are the same as those executed by the access policy display device 200 in the second example embodiment.

In the third example embodiment, it is possible to visualize an access permission/access denial determination for a part in a policy definition that does not have specific descriptions (a part supplemented by the policy generation unit 160).

### Example Embodiment 4

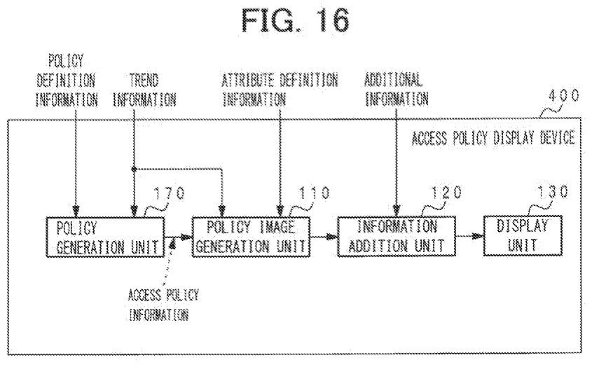

In the fourth example embodiment, the policy generation section generates policy information using rule definition information and trend information used to generate policy information. FIG. 16 is a block diagram showing an example configuration of an access policy display device 400 of the fourth example embodiment.

In addition to the configuration of the access policy display device 100 shown in FIG. 2, the access policy display device 400 comprises a policy generation unit 170.

The policy generation unit 170 generates access policy information by supplementing deficiencies against the policy definition, as illustrated in FIG. 13 (coarse-grained policy definition), and by referencing trend information.

Trend information is information that indicates whether access should be permitted or denied for an attribute value taken by a single attribute or a combination of attribute values of a plurality of attributes. In other words, trend information is information that indicates whether access should be permitted or denied for a condition that combines one or more attribute values when the condition is satisfied. Trend information is, for example, scored.

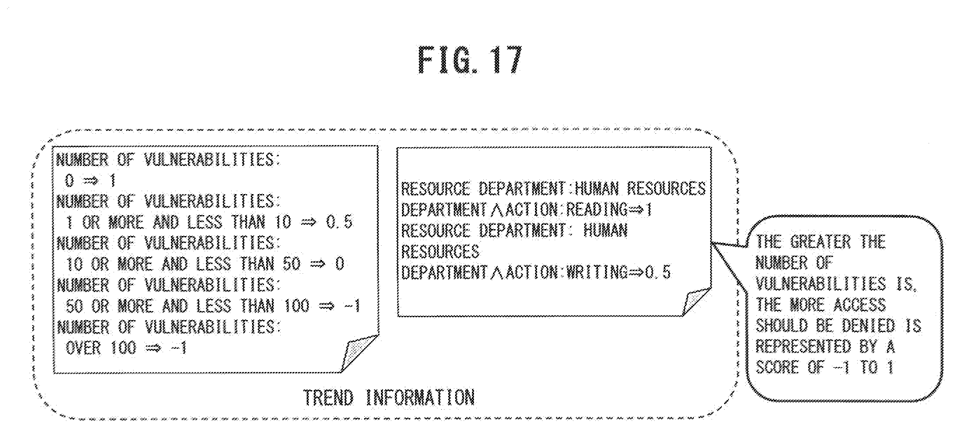

FIG. 17 is an explanatory diagram showing an example of trend information. FIG. 17 illustrates two examples of trend information. Trend information, shown on the left side in FIG. 17, is trend information regarding an attribute of the Number of Vulnerabilities. In the example shown in FIG. 17, the tendency that the greater the number of vulnerabilities is, the more access should be denied is represented by a score of −1 to 1. The closer the score is to “1,” the higher the tendency that access should be permitted.

The trend information shown on the right side in FIG. 17 is trend information using two attributes (an attribute called affiliated department and an attribute called action). In addition, it is possible to represent trend information by combining three or more attributes.

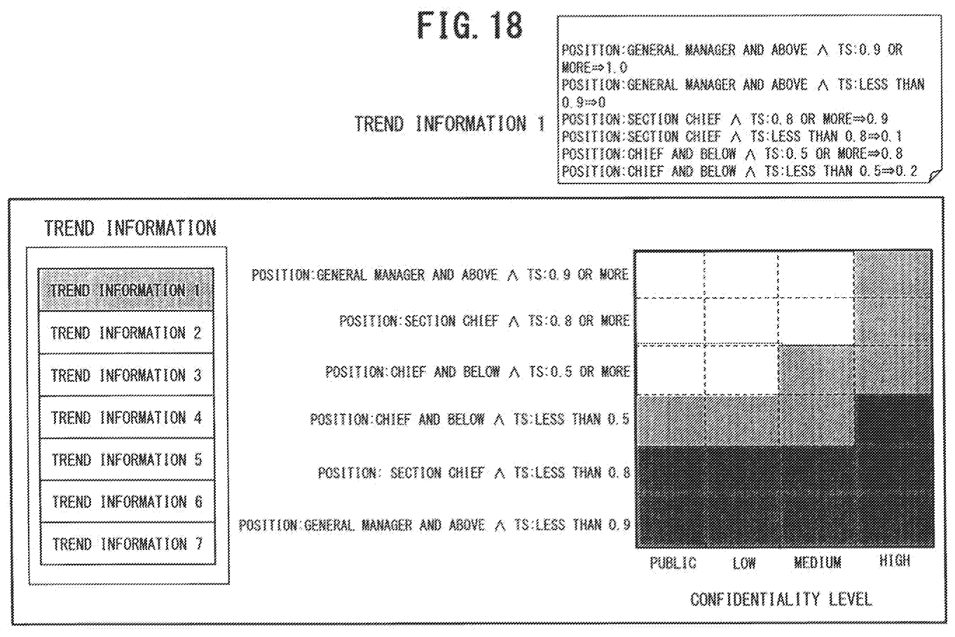

FIG. 18 is an explanatory diagram showing an example display of a policy image generated with reference to trend information. On the left side in FIG. 18, a selection field for trend information is shown. On the right side in FIG. 18, a display of a generated policy image is shown. As illustrated in FIG. 18, it is assumed that there is a plurality of trend information (in an example shown in FIG. 18, trend information 1 to trend information 7). Note that in FIG. 18, TS means Trust Score.

Take the case where the policy generation unit 170 uses Trend Information 1 as an example. Trend Information 1 describes a score when a combination of an attribute value of Attribute: Position and an attribute value of Attribute: Trust Score satisfies a predetermined condition. Note that in an example shown in FIG. 18, predetermined conditions are, for example, that an attribute value of Position is “General Manager or higher” and a Trust Score is 0.9 or higher.

Based on a policy definition, the policy generation unit 170 generates detailed policy information (access policy information) by referring to trend information. Since trend information is information that indicates whether access should be permitted or denied, the policy generation unit 170 can generate detailed policy information by assigning a score or other information that indicates whether access should be permitted or denied to an attribute value or combination of attribute values specified in the policy definition. The policy generation unit 170 can generate detailed policy information by attaching a score or other information indicating a trend toward permitting or denying access to an attribute value or combination of attribute values specified in the policy definition.

The policy image generation unit 110 determines an axe using trend information. That is to say, the policy image generation unit 110 determines a division point in the x-axis direction or the y-axis direction of a two-dimensional image. In other words, the policy image generation unit 110 determines how to divide an image by referring to attribute values or combinations of attribute values for which access tendency is clearly indicated in trend information. For example, the policy image generation unit 110 arranges items (combinations of attribute values) in order of decreasing trend information (refer to the right side of FIG. 18). The division points may be determined based on trend information for both the X and Y axes. Note that a dividing point may be determined based on trend information for both the X-axis and the Y-axis. In that case, two types of trend information can be selected from a trend information selection field on the left side in FIG. 18. On the other hand, for either axis, an attribute may be selected as in the first example embodiment and the second example embodiment. In this case, the number of trend information selected in the trend information selection field is one. Further, a policy image display unit on the right side can display side by side the same number of policy images as the number of attributes selected corresponding to the axis other than the axis on which the division point is determined based on the trend information.

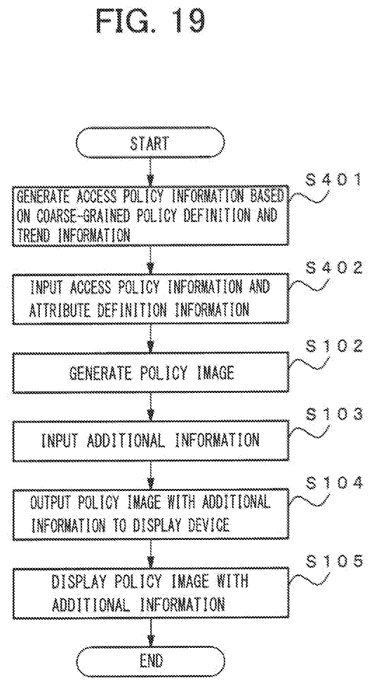

Next, an operation of the access policy display device 400 of the fourth example embodiment is explained with reference to the flowchart in FIG. 19. The process other than the process of steps S401 and S402 is the same as the process executed by the access policy display device 100 in the first example embodiment (refer to FIG. 8). However, the process of step S102 is slightly different from the process of step S102 in the first example embodiment.

In step S401, the policy generation unit 170 generates detailed policy information based on a policy definition and with reference to trend information, as described above.

In step S402, the policy image generation unit 110 inputs attribute definition information, access policy information from the policy generation unit 170, and trend information.

Then, the policy image generation unit 110 generates a policy image (step S102). In this example embodiment, the policy image generation unit 110 determines an axis by referring to trend information when generating the policy image.

Other processes are the same as those executed by the access policy display device 100 of the first example embodiment.

### Modification 1

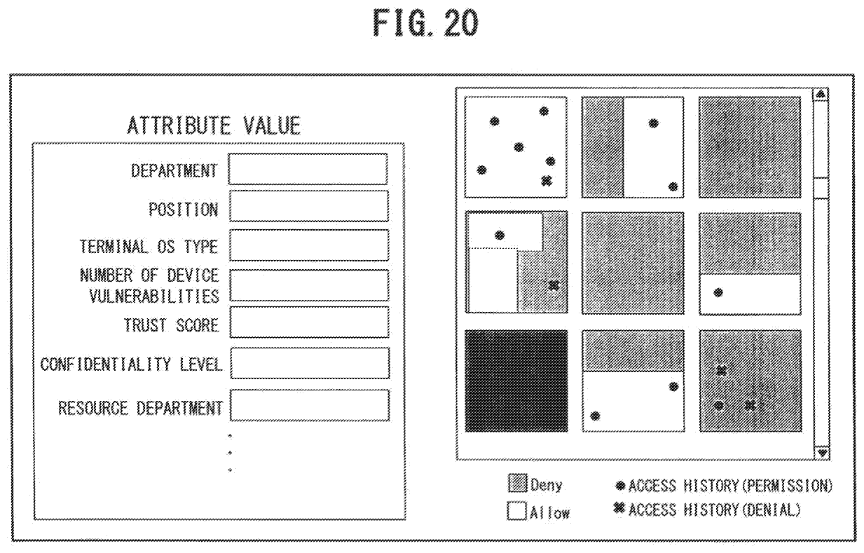

FIGS. 20 to 22 are explanatory diagrams for explaining the first modification. In the second embodiment, an entry interface that can specify a specific attribute value for each attribute is provided, but in the first modification, the method for entering attribute values by a user is simplified.

FIG. 20 shows an example display similar to FIG. 10. The attribute value input unit 140 (refer to FIG. 9) displays a screen such as illustrated on the left side of FIG. 20. The fields displaying all attribute values are blank in the example shown on the left side of FIG. 20.

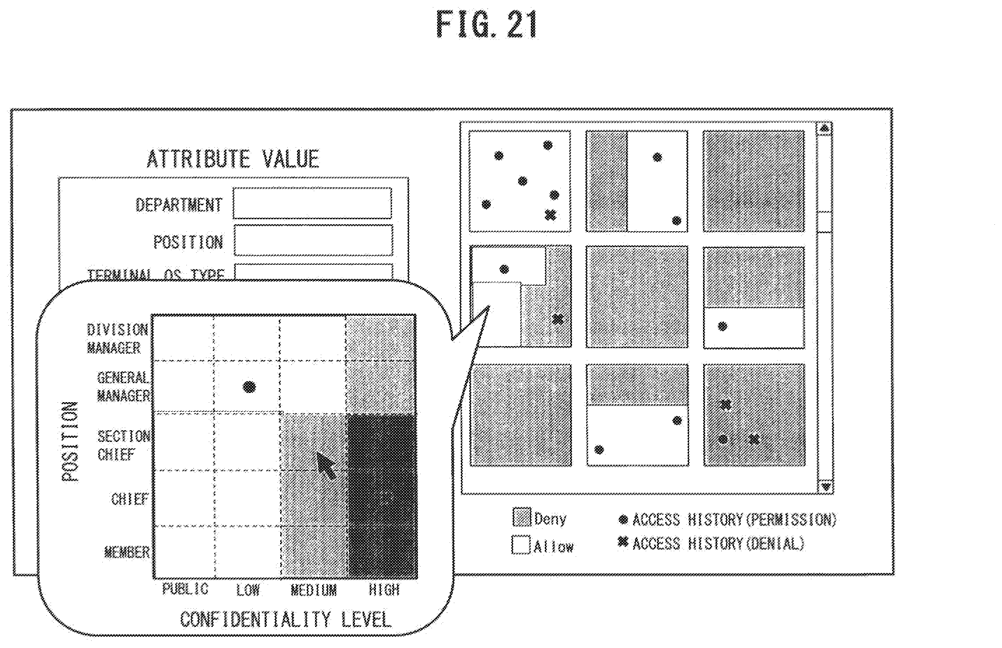

The right side of FIG. 20 shows an example of a plurality of images with access history marked (in the example shown in FIG. 20, nine images, hereafter referred to as access history images). A user can enter attribute values by selecting (for example, clicking) an image. FIG. 21 shows an example of how to select. In the example shown in FIG. 21, it is illustrated that a user has selected an access history image in which attributes X and Y are Confidentiality Level and Position among the nine access history images. Specifically, it is illustrated that the user has selected a region corresponding to “Section Chief” and “Medium” (refer to arrows in FIG. 21).

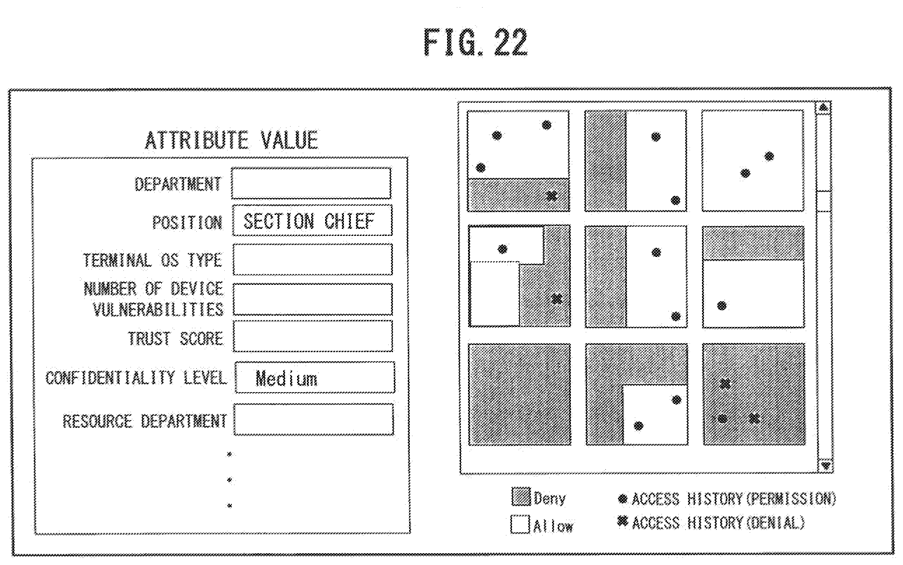

The attribute value input unit 140 detects that a region corresponding to “Section Chief” and “Medium” has been selected. Then, as illustrated in FIG. 22, the attribute value input unit 140 sets “Section Chief” in an attribute value field corresponding to an attribute “Position.” Further, the attribute value input unit 140 sets “Medium” in an attribute value field corresponding to an attribute “Confidentiality level.”

### Modification 2

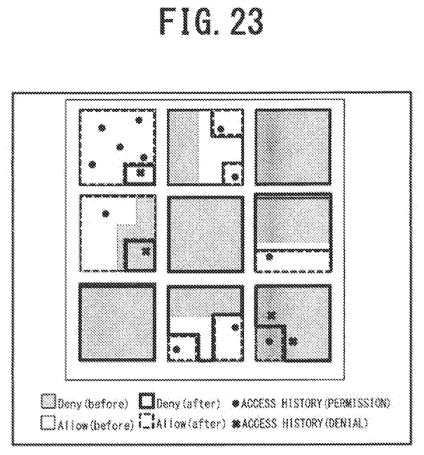

A plurality of pieces of information may be displayed on the display device 130. In the third and fourth example embodiments, the policy generation units 160 and 170 generate access policy information based on the policy definition, as illustrated in FIG. 13. FIG. 23 shows an example in which policy definition information and access policy information are displayed in an overlapping manner. The part displayed as “before” corresponds to an access policy based on the policy definition information. The part displayed as “after” corresponds to an access policy based on the access policy information.

By making a display as illustrated in FIG. 23, it is possible to visualize how an access policy is detailed. Furthermore, for example, it is possible to display an access policy defined in an organization and an access policy defined in a department in the organization so that they can be compared.

A difference between a plurality of access policies may be displayed in color. For example, instead of determining a color based on a ratio of access permissions, the policy image generation unit colors according to a value of [number permitted by one policy-number permitted by the other policy].

When displaying a plurality of policy images, the display order may be changed by assigning a priority to the images. For example, the images may be displayed in order of the largest difference between the regions of access permission or access denial. Alternatively, the images with large discrepancies between an access policy and an access history may be prioritized for display.

Each example embodiment described above can be configured using hardware, but it is also possible to implement them using a computer program.

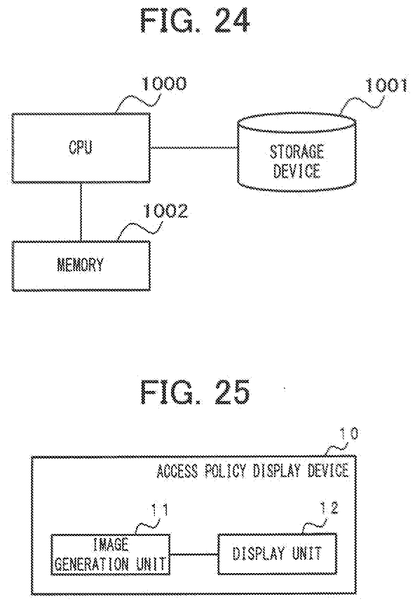

FIG. 24 is a block diagram showing an example of a computer with a CPU. The computer is implemented in an access policy display device. A CPU 1000 implements each function in the above example embodiments by executing a process according to a program (software element: code) stored in a storage device 1001.

That is, the computer can realize functions of the policy image generation unit 110 and information addition unit 120 in the access policy display device 100, shown in FIG. 2. The computer can also realize functions of the policy image generation unit 110, the information addition unit 120, and the attribute value input unit 140 in the access policy display device 200 shown in FIG. 9. The computer can also realize functions of the policy image generation unit 110, information addition unit 120, attribute value determination unit 150, and policy generation unit 160 in the access policy display device 300 shown in FIG. 12. The computer can also realize functions of the policy image generation unit 110, the information addition unit 120, and the policy generation unit 170 in the access policy display device 400, shown in FIG. 16.

The storage device 1001 is, for example, a non-transitory computer readable media. The non-transitory computer readable medium is one of various types of tangible storage media. Specific examples of the non-transitory computer readable media include a magnetic storage medium (for example, hard disk), a magneto-optical storage medium (for example, magneto-optical disk), a CD-ROM (Compact Disc-Read Only Memory), a CD-R (Compact Disc-Recordable), a CD-R/W (Compact Disc-ReWritable), and a semiconductor memory (for example, a mask ROM, a PROM (programmable ROM), an EPROM (Erasable PROM), a flash ROM).

The program may be stored in various types of transitory computer readable media. The transitory computer readable medium is supplied with the program through, for example, a wired or wireless communication channel, i.e., through electric signals, optical signals, or electromagnetic waves.

A memory 1002 is a storage means implemented by a RAM (Random Access Memory), for example, and temporarily stores data when the CPU 1000 executes processing. It can be assumed that a program held in the storage device 1001 or a temporary computer readable medium is transferred to the memory 1002 and the CPU 1000 executes processing based on the program in the memory 1002.

FIG. 25 is a block diagram showing the main part of an access policy display device. The access policy display device 10 shown in FIG. 25 comprises an image generation unit (image generation means) 11 (in the example embodiment, realized by the policy image generation unit 110) which sets an image region for each combination of an attribute value of one attribute and an attribute value of the other attribute in two attributes (for example, Position and Confidentiality Level) selected from two or more attributes (for example, Position, Trust Score, Number of Vulnerabilities, and Confidentiality Level) constituting a condition of an access policy, calculates the degree of access permission or access denial in a plurality of the combinations, and generates an image (for example, a policy image that is a two-dimensional image) in which a plurality of image regions is displayed that allows for distinguishing the degree, and a display (display means) 12 (in the example embodiment, realized by the information addition unit 120 and a display device 130) which displays the image.

The access policy display device 10 can comprise an information addition unit (information addition means) (in the example embodiment, realized by the information addition unit 120) which superimposes access-related information related to access permission or access denial on the image.

The access policy display device 10 can comprise an attribute input unit (attribute input means) (in the example embodiment, realized by the attribute value input unit 140) which accepts input of the attribute value, wherein the image generation unit 11 generates the image by fixing the attribute value of attribute to the input attribute value.

The access policy display device 10 can comprise a policy generation unit (policy generation means) (in the example embodiment, realized by the policy generation unit 120) which generates the access policy based on policy definition information and an attribute value determination unit (attribute value determination means) (in the example embodiment, realized by the attribute value determination unit 150) which determines the attribute value based on the policy definition information, wherein the image generation unit 11 generates the image by fixing the attribute value of attribute to the determined attribute value.

1. An access policy display device comprising:
an image generation unit which sets an image region for each combination of an attribute value of one attribute and an attribute value of another attribute in two attributes selected from two or more attributes constituting a condition of an access policy, calculates a degree of access permission or access denial in a plurality of the combinations, and generates an image in which a plurality of the image regions is displayed that allows for distinguishing the degree; and
a display which displays the image.

2. The access policy display device according to claim 1, further comprising
an information addition unit which superimposes access-related information related to access permission or access denial on the image.

3. The access policy display device according to claim 1, wherein
the image generation unit generates a plurality of images with different types of combinations of the two attributes,
the display displays the plurality of images on a single screen.

4. The access policy display device according to claim 3, further comprising
an attribute value input unit which accepts input of the attribute value,
wherein the image generation unit generates the image by fixing the attribute value of attribute to the input attribute value.

5. The access policy display device according to claim 3, further comprising:
a policy generation unit which generates the access policy based on policy definition information; and
an attribute value determination unit which determines the attribute value based on the policy definition information,
wherein the image generation unit generates the image by fixing the attribute value of attribute to the determined attribute value.

6. The access policy display device according to claim 2, wherein
the image generation unit generates a plurality of images with different types of combinations of the two attributes,
the display displays the plurality of images on a single screen.

7. The access policy display device according to claim 6, further comprising:
an attribute value input unit which accepts input of the attribute value,
wherein the image generation unit generates the image by fixing the attribute value of attribute to the input attribute value.

8. The access policy display device according to claim 6, further comprising:
a policy generation unit which generates the access policy based on policy definition information; and
an attribute value determination unit which determines the attribute value based on the policy definition information,
wherein the image generation unit generates the image by fixing the attribute value of attribute to the determined attribute value.

9. An access policy display method comprising:
setting an image region for each combination of an attribute value of one attribute and an attribute value of another attribute in two attributes selected from two or more attributes constituting a condition of an access policy, calculating a degree of access permission or access denial in a plurality of the combinations, and generating an image in which a plurality of the image regions is displayed that allows for distinguishing the degree; and
displaying the image.

10. The access policy display method according to claim 9, further comprising:
superimposing access-related information related to access permission or access denial on the image.

11. A non-transitory computer readable recording medium storing an access policy display program for causing a computer to execute:
setting an image region for each combination of an attribute value of one attribute and an attribute value of another attribute in two attributes selected from two or more attributes constituting a condition of an access policy, calculating a degree of access permission or access denial in a plurality of the combinations, and generating an image in which a plurality of the image regions is displayed that allows for distinguishing the degree; and
displaying the image.

12. The non-transitory computer readable recording medium according to claim 11, wherein
the access policy display program causes the computer to execute
superimposing access-related information related to access permission or access denial on the image.
